(19) United States
(12) Patent Application Publication
(10) Pub. No.: US 2006/0020052 A1
(43) Pub. Date: Jan. 26, 2006

(54) Photocatalyst-containing silicone resin composition and coated article having cured coating film therefrom

(76) Inventors: Akira Tsujimoto, Ikoma-shi (JP); Hiroshi Tamaru, Nishinomiya-shi (JP); Kouichi Takahama, Amagasaki-shi (JP); Keisuke Tanaka, Ichihara-shi (JP); Hirokazu Tanaka, Ichihara-shi (JP); Shigeki Obana, Takarazuka-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/522,014

(22) PCT Filed: Jul. 24, 2003
(86) PCT No.: PCT/JP03/09374

§ 371 Date: Aug. 4, 2005

(30) Foreign Application Priority Data
Jul. 26, 2002 (JP) 2002-218248

(51) Int. Cl. B29C 71/04

(52) U.S. Cl. 522/71

(57) ABSTRACT

A photocatalyst-containing silicone resin composition is provided, which can be baked at a relatively low temperature (e.g., approximately 100° C.) to form a film having high transparency, durability and photocatalysis. This composition comprises TiO₂, a Zr containing compound, a hydrolyzable silicone resin and a Si containing compound containing SiO₂ particles. A content of the Zr containing compound in terms of its oxide is 0.005 to 0.1 parts by weight with respect to 1 part by weight of TiO₂. A content of the Si containing compound in terms of its oxide is 0.5. to 6.0 parts by weight with respect to 1 part by weight of TiO₂. A content of the SiO₂ particles is 0.1 to 3 parts by weight with respect to 1 part by weight in terms of an oxide of the hydrolyzable silicone resin.

### TECHNICAL FIELD

The present invention relates to a photocatalyst-containing silicone resin composition having the capability of providing a film with high photocatalysis and durability at a relatively low temperature, and coated articles with a cured film of the same composition.

### BACKGROUND ART

By irradiating a light (UV light) having an excitation wavelength (e.g., 400 nm) to a photocatalyst represented by titania, positive holes are generated. The positive holes capture electrons from the surrounding OH⁻ (hydroxide ions) or the like to generate very unstable OH radicals (active oxygen). The OH radicals have the capability of decomposing organic matter by oxidization. Therefore, by coating the photocatalyst on a base material, a self-cleaning effect of decomposing contaminants adhered to the base material (e.g., carbon distillate found in the exhaust gas of automobiles or tar), odor eliminating effect of decomposing unpleasant odor components represented by amine compounds and aldehyde compounds, and antibacterial/mildewproof effects of preventing the propagation of bacterias represented by Bacillus coli and Staphylococcus aureus are expected.

In addition, when the film containing the photocatalyst is formed on the base material, there is an advantage that the contact angle of water on the film surface is reduced to improve hydrophilicity (water wettability) because the organic matter adhered to the film surface is decomposed/removed by the OH radicals. Due to this improvement of hydrophilicity, an antifogging effect of preventing that indoor members such as a mirror or a glass surface are fogged up, and an antifouling effect that contaminants adhered to outdoor members are cleaned by rainwater are expected. Moreover, an antistatic effect resulting from photocatalysis can be expected

To provide such a photocatalyst to the base material, it is known to apply a composition containing a silicone resin as the main component and the photocatalyst on the base material, and then perform heat curing to form a film.

As this kind of composition, for example, it was proposed in Japanese Patent Early Publication [kokai] No.2001-146573 to use a coating composition containing a silicone resin and an inorganic filler such as silica or titania. This silicone resin is a polymer of a 4-functional alkoxysilane or its partial hydrolysis product and a 2-functional or 3-functional alkoxysilane. By applying this coating composition on the base material, and then baking, the film containing the photocatalyst can be obtained. However, in this method, since it is needed to perform the baking at a high temperature of 250 to 350° C., the kind of the base material for the film formation is limited. Due to this reason, a composition that can be baked at a lower temperature is being desired.

In addition, Japanese Patent Early Publication [kokai] No. 9-328336 discloses a composition for forming a film with photocatalyst activity. This composition contains (1) titania fine particles having an average grain size of less than 100 nm, (2) a Zr containing compound, and (3) a Si containing compound, and weight ratios in terms of their oxides of (2)/(1) and (3)/(1) are 0.02 to 0.5 and 0.2 to 2.5, respectively. According to this composition, it is possible to form a film that is excellent in photocatalyst activity, mechanical strength and chemical resistance. In this composition, however, it is needed to perform a heat treatment to the composition applied on the base material at a high temperature (e.g., 650° C.). Therefore, the base material must possess heat resistance to stand up this heat treatment.

Furthermore, Japanese Patent Early Publication [kokai] No. 2002-161238 discloses a coating composition containing a silicone resin and an organometallic compound. This organometallic compound is represented by the general formula of R¹ₘM (OR²)ₙ, wherein “M” is at least one metal selected from the group consisting of Ti, Al, Zr, and ZrAl, “R¹” and “R²” respectively designate hydrogen or a monovalent organic group, which may be equal to or different from each other, and “n” and “m” are zero or positive integers determined such that the total (m+n) is equal to the valence of the metal “M”. In addition, if necessary, an inorganic filler such as titania having photocatalysis, silica and alumina is added to this composition. According to this composition, it is possible to form a film having excellent waterproof and alkali resistance, while keeping the same antifouling property and hydrophilicity as the conventional art. However, in this composition, a heat treatment is performed to the composition applied on the base material at a high temperature (e.g., 300° C.).

Thus, from the viewpoint of expanding the applicability of photocatalysis by reducing the heat-treatment temperature, the conventional photocatalyst-containing compositions still have plenty room for improvement.

### SUMMARY OF THE INVENTION

Therefore, a primary concern of the present invention is to provide a photocatalyst-containing silicone resin composition, which can be baked at a relatively low temperature (e.g., approximately 100° C.) to form a film having high photocatalysis, durability, and high transparency.

That is, this composition comprises TiO₂, a Zr containing compound, a hydrolyzable silicone resin and a Si containing compound containing SiO₂ particles, and is characterized in that a content of the Zr containing compound in terms of an oxide thereof is 0.005 to 0.1 parts by weight with respect to 1 part by weight of TiO₂, a content of the Si containing compound in terms of an oxide thereof is 0.5 to 6.0 parts by weight with respect to 1 part by weight of TiO₂, and a content of the SiO₂ particles is 0.1 to 3 parts by weight with respect to 1 part by weight in terms of an oxide of the hydrolyzable silicone resin.

In the above composition of the present invention, it is preferred that the content of the Zr containing compound is 0.005 to 0.02 parts by weight. In this case, it is possible to further improve waterproof, alkali resistance, wear resistance, and durability of the film.

In addition, in the composition of the present invention, it is preferred that the SiO₂ particles comprises a colloidal silica having an average particle size of 60 nm or less. In this case, it is possible to further improve performance such as wear resistance and appearance of the film.

A further concern of the present invention is to provide a cured film obtained by heat curing the photocatalyst-containing silicone resin composition described above, and a coated article with the cured film obtained by heat curing the same composition.

These and further features and advantages of the present invention will be clearly understood from the best mode for carrying out the invention explained below.

### BEST MODE FOR CARRYING OUT THE INVENTION

Preferred embodiments of the present invention are explained below in detail.

The photocatalyst-containing silicone resin composition of the present invention contains TiO₂, a Zr containing compound, and a Si containing compound as essential components. The Si containing compound at least contains a hydrolyzable silicone resin and SiO₂ particles. A content of the Zr containing compound in terms of an oxide (ZrO₂ conversion) thereof is 0.005 to 0.1 parts by weight with respect to 1 part by weight of TiO₂. A content of the Si containing compound in terms of an oxide (SiO₂ conversion) thereof is 0.5 to 6.0 parts by weight with respect to 1 part by weight of TiO₂. In addition, in the Si containing compound, a content of the SiO₂ particles is 0.1 to 3 parts by weight with respect to 1 part by weight in terms of an oxide (SiO₂ conversion)of the hydrolyzable silicone resin.

By applying and curing the composition prepared according to the above-defined compounding ratio, it is possible to obtain a film having high photocatalysis effects such as a self-cleaning effect, odor eliminating effect, antibacterial effect, mildewproof effect, antifogging effect and an antifouling effect as well as good appearance, hydrophilicity, durability, and alkali resistance. In addition, this film can be dried/cured at a relatively low temperature of from room temperature to 200° C.

As to TiO₂, it is preferred that it has an average grain size of 80 nm or less. In this case, it is possible to secure excellent photocatalysis, and further improve the wear resistance of the film. A lower limit of the average grain size of TiO₂ is not restricted. For example, it is preferred that it is 5 nm or more because the photocatalyst can be uniformly dispersed in the film applied on the substrate by preventing coagulation of TiO₂ at the time of applying the composition.

When the content of the Zr containing compound is less than 0.005 parts by weight, performance such as waterproof, alkali resistance, wear resistance and durability is not obtained sufficiently. When the content exceeds 0.1 parts by weight, gelation or coagulation of the composition, deterioration of the film appearance, or a reduction in photocatalysis may occur. On the other hand, when the content of the Si containing compound is less than 0.5 parts by weight, a sufficient film strength can not be obtained. When the content exceeds 6.0 parts by weight, the photocatalysis becomes insufficient. In addition, when the content of the SiO₂ particles is less than 0.1 parts by weight, the photocatalysis lowers. When the content exceeds 3 parts by weight, the film strength decreases in addition to a deterioration in photocatalysis.

To further improve the performance such as waterproof, alkali resistance, wear resistance and durability, it is preferred that the content of the Zr containing compound in terms of an oxide (ZrO₂ conversion) thereof is 0.005 to 0.02 parts by weight, and particularly 0.005 to 0.018 parts by weight with respect to 1 part by weight of TiO₂.

In addition, when using a colloidal silica having an average grain size of 60 nm or less as the SiO₂ particles, it is possible to further improve the wear resistance and the appearance. A lower limit of the average grain size of SiO₂ is not restricted. For example, it is preferred to be 5 nm or more because a high stability of the composition and good wear resistance of the film can be obtained by preventing coagulation of SiO₂ at the time of applying the composition.

The hydrolyzable silicone resin that is the essential component of the present invention is used as a binder resin and a film-forming component. A state of the hydrolyzable silicone resin is not restricted. For example, it may be in a solution state or a dispersion liquid state.

As to the hydrolyzable silicone resin, an hydrolyzable organosilane represented by the following general formula (1) or its (partially) hydrolyzed product can be used.
R³ₚSiX₄₋ₚ (1)

In the above formula (1), “R³” is a substituted or non-substituted hydrocarbon group (monovalent hydrocarbon group), which can be bonded to Si atom by single bonding. When there are a plurality of “R³”, they may be equal to or different from each other. “P” is an integer of 0 to 3. In addition, “X” designates a hydrolyzable group. When there are a plurality of hydrolyzable groups, they may be equal to or different from each other.

As to the “R³”, for example, it is preferred to use a substituted or non-substituted monovalent hydrocarbon group having a carbon number of 1 to 8. Specifically, the “R³” comprises alkyl groups such as methyl group, ethyl group, propyl group, butyl group, pentyl group, hexyl group, heptyl group and octyl group; cycloalkyl groups such as cyclopentyl group; aralkyl groups such as 2-phenylethyl group, 2-phenylpropyl group and 3-phenylpropryl group; aryl groups such as phenyl group and tolyl group; alkenyl groups such as vinyl group and allyl group; halogen substituted hydrocarbon groups such as chloromethyl group, γ-chloropropyl group and 3,3,3-trifluoropropyl group; substituted hydrocarbon groups such as γ-glycidoxypropyl group, 3,4-epoxy cyclohexyl ethyl group and γ-mercaptopropyl group. In these “R³”, it is preferred to use an alkyl group or a phenyl group having a carbon number of 1 to 4 because they are easy to synthesize and get. The alkyl group having the carbon number of 3 or more may be of a straight chain such as n-propyl group and n-butyl group, or a branched chain such as isopropyl group, isobutyl group and t-butyl group.

In the above formula (1), “X” is a same or different hydrolyzable group, which is not restricted. For example, it comprises alkoxy group, oxime group, enoxy group, amino group, aminoxy group and amide group. Specifically, the hydrolyzable organosilane comprises mono-, di-, tri- or tetra-functional alkoxysilanes, acetoxysilanes, oximesilanes, enoxysilanes, aminosilanes, aminoxysilanes and amidosilanes, in which the value of “p” in the general formula (1) is an integer of 0 to 3. In these compounds, it is preferred to use the alkoxysilanes having an alkoxy group (OR) as the “X” because it is easy to synthesize and get.

As to the alkoxy group, it is preferred that the carbon number of the alkyl group (R) is in a range of 1 to 8. In this case, it is easy to get, and the hydrolyzable silicone resin can be easily prepared. In addition, a condensation reaction easily proceeds at the time of applying and curing the composition. As a result, it is possible to obtain a film having a high hardness. Specifically, the alkyl group having the carbon number of 1 to 8 in the alkoxy group comprises methyl group, ethyl group, propyl group, butyl group, pentyl group, hexyl group, heptyl group and octyl group. The alkyl group having the carbon number of 3 or more in this alkoxy group may be of a straight chain such as n-propyl group, n-butyl group, or a branched chain such as isopropyl group, isobutyl group and t-butyl group.

In the case of using the (partially) hydrolyzed product of the above-described hydrolyzable organosilane as the hydrolyzable silicone resin, it is needed to react the hydrolyzable organosilane with water. In this case, it is preferred that a molar equivalent ratio (H₂O/X or H₂O/OR) of water (H₂O) relative to the hydrolyzable group such as alkoxy group (OR) is in a range of 0.3 to 5, more preferably 0.35 to 4, and particularly 0.4 to 3.5. When this value is less than 0.3, there is a fear that the cured film becomes brittle due to an insufficient progress of the hydrolysis reaction. On the other hand, when the value exceeds 5.0, there is a tendency that gelation of the obtained hydrolyzable silicone resin proceeds in a short time period, so that the shelf life of the composition may lower.

In the case of using an alkoxysilane as the hydrolyzable organosilane, and (partially) hydrolyzing it, it is preferred to use a catalyst, if necessary. From the viewpoint of shortening the production time, for example, it is preferred to use, as the catalyst, an organic acid such as acetic acid, monochloroacetic acid, citric acid, benzoic acid, dimethylmalonic acid, formic acid, propionic acid, glutaric acid, maleic acid, malonic acid, toluenesulfonic acid and oxalic acid; an inorganic acid such as hydrochloric acid, nitric acid, halogenated silane; and an acidic sol filler such as acidic colloidal silica and titanium oxide sol. Each of these catalysts may be used by itself, or a combination of two or more of them may be used. The hydrolysis reaction can be performed at an elevated temperature of 40 to 100° C., if necessary.

In addition, the (partial) hydrolysis reaction may be performed in the presence of a solvent, if necessary. As such a solvent, a hydrophilic organic solvent can be used, which comprises lower aliphatic alcohols such as methanol, ethanol, isopropanol, n-butanol and isobutanol; ethyleneglycol and its derivative such as ethyleneglycol, ethyleneglycol monobutylether and ethyleneglycol monoethylether acetate; diethyleneglycol and its derivative such as diethyleneglycol and diethyleneglycol monobutylether; and diacetone alcohols. Each of these solvents may be used by itself, or a combination of two or more of them may be used. In addition to the hydrophilic organic solvent, one or more of toluene, xylene, hexane, heptane, ethyl acetate, butyl acetate, methylethylketone, methylisobutylketone and methylethylketoxime may be used.

To accelerate the catalyst reaction, for example, it is possible to use an metal carboxylate such as alkyl titanate, tin octylate, dibutyl tin laurate and dioctyl tin dimaleate, amine such as dibutylamine-2-hexoate, dimethylamine acetate, ethanolamine acetate, quaternary ammonium carboxylate such as tetramethylammonium acetate, amine; amine silane coupling agent, aluminum compound such as aluminum alkoxide and aluminum chelate, alkali catalyst, or a titanium compound. These also function as a catalyst for polycondensation of the hydrolyzable silicone resin at the film formation, and facilitate curing of the film.

A molecular weight of the thus obtained (partially) hydrolyzed product of the alkoxysilane is not specifically restricted. For example, it is preferred that the weight-average molecular weight is in a range of 500 to 1000. when the weight-average molecular weight is less than 500, the (partially) hydrolyzed product may become unstable. When it exceeds 1000, there is a fear that a sufficient film hardness can not be maintained.

In addition, the Zr containing compound that is the essential component of the composition of the present invention facilitates the polymerization reaction by dehydration and dealcoholization at the film formation, thereby increasing crosslinking density of the film, improving the adhesion between the film and the substrate, and increasing the film hardness. Moreover, it contributes to improvements in hydrophobicity, waterproof, and alkali resistance of the film.

The Zr containing compound comprises a zirconium alkoxide, zirconium chelate compound and a zirconium acetate. In particular, when using at least one of Zr(OC₄H₉)₃(C₅H₇O₂) and Zr(OC₄H₉)(C₅H₇O₂)(C₆H₉O₃)₂, the film having high photocatalysis and durability can be obtained by forming the film at a relatively low temperature of from room temperature to 200° C.

In addition, TiO₂ is the essential component of the present invention, and provides the photocatalysis. In particular, when using anatase-type TiO₂, it is possible to remarkably facilitate curing at the time of the film formation in addition to excellent photocatalysis. Furthermore, the photocatalyst performance appears after the elapse of a short time period from the film formation, and is maintained for a long time period.

As the photocatalyst, only TiO₂ may be used. Alternatively, in combination with TiO₂, it is possible to use at least one selected from another photocatalysts, for example, monometal oxides such as zinc oxide, tin oxide, iron oxide, zirconium oxide, tungsten oxide, chromium oxide, molybdenum oxide, ruthenium oxide, germanium oxide, lead oxide, cadmium oxide, copper oxide, vanadium oxide, niobium oxide, tantalum oxide, manganese oxide, cobalt oxide, rhodium oxide, nickel oxide and rhenium oxide, or strontium titanate. In addition, a raw material having the capability of eventually exhibiting the photocatalysis, for example, a titanium alkoxide may be used.

In the case of adding TiO₂ to prepare the composition, a state of TiO₂ is not restricted. For example, TiO₂ may be in a state such as powder, fine particles or sol particles dispersed in a solution so as to be dispersible in the composition. In the case of using a sol state such as the sol particles dispersed in the solution, and particularly the sol state having a pH value smaller than 7, it is possible to further accelerate curing at the film formation, and therefore improve the convenience. A dispersion medium used when such a TiO₂ sol is added is not restricted if TiO₂ fine particles can be uniformly dispersed therein. For example, either an aqueous or non-aqueous solvent may be used.

As the aqueous solvent, water may be used by itself. Alternatively, it is possible to use a mixed dispersion medium of water and at least one selected from hydrophilic organic solvents, for example, lower aliphatic alcohols such as methanol, ethanol, isopropanol, n-butanol, isobutanol; ethyleneglycol, ethyleneglycol derivatives such as ethyleneglycol monobutylether and ethyleneglycol monobutylether acetate; diethyleneglycol, diethyleneglycol derivative such as diethyleneglycol monobutylether; and diacetone alcohol. In particular, when using the mixed dispersion medium of water and methanol, it is excellent in dispersion stability of TiO₂ fine particles and drying characteristics of the dispersion medium after the composition is applied. In addition, when using such an aqueous sol, it allows the TiO₂ sol to have a function of an acid catalyst for hydrolyzing the hydrolyzable organosilane.

On the other hand, as the non-aqueous solvent, for example, it is possible to use a hydrophilic organic solvent used for the mixed dispersion medium described above or at least one of hydrophobic organic solvents such as toluene and xylene. In particular, when using methanol, it is excellent in dispersion stability of the photocatalyst fine particles and drying characteristics of the dispersion medium after the composition is applied.

As SiO₂ that is the essential component of the present invention, for example, it is possible to use a powder SiO₂, or a SiO₂ sol (colloidal silica). As the colloidal silica, for example, an aqueous colloidal silica that can be dispersed in water, or a non-aqueous colloidal silica that can be dispersed in an organic solvent such as alcohols can be used. In general, such a colloidal silica contains 20 to 50 wt % of silica as the solid content. From this value, the content of silica can be determined.

In the case of using the aqueous colloidal silica, water included as the dispersion medium in this aqueous colloidal silica can be used to (partially) hydrolyze the hydrolyzable organosilane. That is, when the hydrolyzable organosilane and the aqueous colloidal silica are added at the time of preparing the composition of the present invention, water of the dispersion medium is used to hydrolyze the hydrolyzable organosilane and generate the silicone resin. An amount of water in the aqueous colloidal silica is added to the amount of water used to (partially) hydrolyze the hydrolyzable organosilane. The aqueous colloidal silica is usually obtained from water glass, and its marketed product is easy to get.

The non-aqueous colloidal silica that can be dispersed in the organic solvent can be easily prepared by substituting an organic solvent for water of the aqueous colloidal silica. This non-aqueous colloidal silica is also easy to get as a marketed product. In the non-aqueous colloidal silica, as the organic solvent, in which colloidal silica is dispersed, it is possible to use a hydrophilic organic solvent, for example, a lower aliphatic alcohol such as methanol, ethanol, isopropanol, n-butanol, isobutanol; ethyleneglycol, ethyleneglycol derivative such as ethyleneglycol monobutylether, ethyleneglycol monobutylether acetate; diethyleneglycol, diethyleneglycol derivative such as diethyleneglycol monobutylether, and diacetone alcohol. Each of these organic solvents may be used by itself, or a combination of two or more of them may be used. In combination with theses hydrophilic organic solvent, one or more of toluene, xylene, hexane, heptane, ethyl acetate, butyl acetate, methylethylketone, methylisobutylketone, methylethylketoxime can be used.

To uniformly disperse the colloidal silica in the dispersion medium, conventional dispersing methods such as a homogenizer, disper mixer, paint shaker and a bead mill are available.

In the present invention, there is no limitation in the kind of substrate on which the composition of the present invention is applied. For example, the film can be formed by applying the composition on various kinds of substrates including organic and inorganic materials. For example, plastics, glass, metals, or a mirror obtained by forming a metal film on the glass can be used as the substrate. As to the mirror, the film of the composition of the present invention may be formed on a surface of the metal film, or the glass surface.

Before applying the composition on the substrate, it is preferred to perform preliminary washing in order to uniformly form the film or improve the adhesion of the film. For example, the preliminary washing comprises alkali cleaning, ammonium fluoride cleaning, plasma cleaning and UV cleaning.

To apply the composition on the substrate, conventional applying methods such as brush painting, spray coating, dipping, dip coating, roll coating, flow coating, curtain coating, knife coating, spin coating and bar coating are available.

By heating the obtained film, if necessary, a condensation polymerization reaction of the silicone resin in the composition proceeds to obtain a cured film of the composition. At this time, the film formation can be carried out at a relatively low temperature of from room temperature to 200° C. Therefore, when the photocatalyst-containing resin composition of the present invention is used as a coating composition, the film can be formed by applying the composition on a substrate, and performing drying/curing at a lower temperature than the conventional art. As a result, a material having a poor heat resistance, which could not be used as the substrate in the conventional art, can be used in the present invention. Thus, the present invention provides a remarkable advantage of increasing a degree of freedom of selection for the substrate material.

### EXAMPLES

The present invention is explained in detail according to Examples. However, the present invention is not restricted to those Examples. In the following description, unless otherwise specified, “parts” and “%” mean “parts by weight”, and “wt %”, respectively. In addition, a calibration curve for standard polystyrene was prepared by use of GPC (Gel Permeation Chromatography: “HLC8020” manufactured by TOSOH CORPORATION), and molecular weight was determined from its corresponding value.

### Example 1

356 parts of methanol was added into 208 parts of tetraethoxysilane, and then 18 parts of water and 18 parts of 0.01 mol/L hydrochloric acid were mixed thereto. A resultant mixture was sufficiently mixed by using a disper mixer. Subsequently, the resultant mixture was kept at 60° C. for 2 hours in a thermostatic chamber to obtain a silicone resin having a weight-average molecular weight of 950. To this silicone resin, a titanium oxide aqueous sol (solid content: 21%, average particle size: 60 nm) as TiO₂, Zr(OC₄H₉)₃(C₅H₇O₂) as the Zr containing compound, and a silica methanol sol (average particle size: 50 nm) as SiO₂ particles were added.

As to a weight ratio in terms of oxides of these components at this time, (weight of TiO₂):(weight of the Zr containing compound):(weight of the silicone resin):(weight of the SiO₂ particles) is 1:0.05:1:0.5. This was diluted by methanol such that the total solid content is 5%. As a result, a photocatalyst containing silicone resin composition of Example 1 was obtained.

After the obtained composition was left to stand for 1 hour from the preparation, it was applied on a glass substrate by a spin coater, and baked for 10 minutes at 100° C. to obtain a coating film thereon.

### Example 2

A photocatalyst containing silicone resin composition of Example 2 was produced according to a substantially same method as Example 1 except for using Zr(OC₄H₉)(C₅H₇O₂)(C₆H₉O₃)₂ as the Zr containing compound. A coating film of this composition was formed on a glass substrate according to the same method as Example 1.

### Example 3

A photocatalyst containing silicone resin composition of Example 3 was produced according to a substantially same method as Example 1 except that (weight of TiO₂):(weight of the Zr containing compound):(weight of the silicone resin):(weight of the SiO₂ particles) is 1:0.01:1:0.5. A coating film of this composition was formed on a glass substrate according to the same method as Example 1.

### Example 4

A photocatalyst containing silicone resin composition of Example 4 was produced according to a substantially same method as Example 1 except that (weight of TiO₂):(weight of the Zr containing compound):(weight of the silicone resin):(weight of the SiO₂ particles) is 1:0.1:1:0.5. A coating film of this composition was formed on a glass substrate according to the same method as Example 1.

### Example 5

A photocatalyst containing silicone resin composition of Example 5 was produced according to a substantially same method as Example 1 except that (weight of TiO₂):(weight of the Zr containing compound):(weight of the silicone resin):(weight of the SiO₂ particles) is 1:0.05:1.35:0.15. A coating film of this composition was formed on a glass substrate according to the same method as Example 1.

### Example 6

A photocatalyst containing silicone resin composition of Example 6 was produced according to a substantially same method as Example 1 except that (weight of TiO₂):(weight of the Zr containing compound):(weight of the silicone resin):(weight of the SiO₂ particles) is 1:0.05:0.5:1. A coating film of this composition was formed on a glass substrate according to the same method as Example 1.

### Example 7

A photocatalyst containing silicone resin composition of Example 7 was produced according to a substantially same method as Example 1 except for using tetraethoxysilane as the silicone resin. A coating film of this composition was formed on a glass substrate according to the same method as Example 1.

### Example 8

A photocatalyst containing silicone resin composition of Example 8 was produced according to a substantially same method as Example 1 except that (weight of TiO₂):(weight of the Zr containing compound):(weight of the silicone resin):(weight of the SiO₂ particles) is 1:0.05:0.5:0.25. A coating film of this composition was formed on a glass substrate according to the same method as Example 1.

### Example 9

A photocatalyst containing silicone resin composition of Example 9 was produced according to a substantially same method as Example 1 except that (weight of TiO₂):(weight of the Zr containing compound):(weight of the silicone resin):(weight of the SiO₂ particles) is 1:0.05:3:1.5. A coating film of this composition was formed on a glass substrate according to the same method as Example 1.

### Example 10

A photocatalyst containing silicone resin composition of Example 10 was produced according to a substantially same method as Example 1 except for using a silica aqueous sol (average particle size: 100 nm) as the SiO₂ particles. A coating film of this composition was formed on a glass substrate according to the same method as Example 1.

### Comparative Example 1

A photocatalyst containing silicone resin composition of Comparative Example 1 was produced according to a substantially same method as Example 1 except for not using the Zr containing compound. A coating film of this composition was formed on a glass substrate according to the same method as Example 1.

### Comparative Example 2

A photocatalyst containing silicone resin composition of Comparative Example 2 was produced according to a substantially same method as Example 1 except that (weight of TiO₂):(weight of the Zr containing compound):(weight of the silicone resin):(weight of the SiO₂ particles) is 1:0.2:1:0.5. A coating film of this composition was formed on a glass substrate according to the same method as Example 1.

### Comparative Example 3

A photocatalyst containing silicone resin composition of Comparative Example 3 was produced according to a substantially same method as Example 1 except that (weight of TiO₂):(weight of the Zr containing compound):(weight of the silicone resin):(weight of the SiO₂ particles) is 1:0.05:1.4:0.1. A coating film of this composition was formed on a glass substrate according to the same method as Example 1.

### Comparative Example 4

A photocatalyst containing silicone resin composition of Comparative Example 4 was produced according to a substantially same method as Example 1 except that (weight of TiO₂):(weight of the Zr containing compound):(weight of the silicone resin):(weight of the SiO₂ particles) is 1:0.05:0.3:1.2. A coating film of this composition was formed on a glass substrate according to the same method as Example 1.

### Comparative Example 5

A photocatalyst containing silicone resin composition of Comparative Example 5 was produced according to a substantially same method as Example 1 except that (weight of TiO₂):(weight of the Zr containing compound):(weight of the silicone resin):(weight of the SiO₂ particles) is 1:0.05:0.2:0.1. A coating film of this composition was formed on a glass substrate according to the same method as Example 1.

### Comparative Example 6

A photocatalyst containing silicone resin composition of Comparative Example 6 was produced according to a substantially same method as Example 1 except that (weight of TiO₂):(weight of the Zr containing compound):(weight of the silicone resin):(weight of the SiO₂ particles) is 1:0.05:7:3.5. A coating film of this composition was formed on a glass substrate according to the same method as Example 1.

With respect to each of the coating films obtained in Examples 1 to 10 and Comparative Examples 1 to 6, the following evaluations were performed.

1. Appearance Evaluation

A haze value of the coating film was determined according to JIS K7105 6.4.

2. Photocatalysis Evaluation

An ultraviolet ray (wavelength 365 nm ) was irradiated to the coating film under conditions of 3 mW/cm² for 10 hours immediately after the preparation of the coating film. After the irradiation, a contact angle of water on the coating film surface was measured.

3. Wear Resistance

According to JIS K7204, a taber abrasion test was performed to the coating film. That is, the test was performed by using a taber-type abrasion tester (YASUDA SEIKI SEISAKUSHO., LTD.) under conditions of 100 rotations of an abrading wheel “CS-10F” and a load of 250 g (2.45 N). The haze value of the film surface was measured according to JIS K7105 6.4 before and after the abrasion test. In addition, a haze difference between the haze value measured in the appearance evaluation before the taber abrasion test and the haze value measured in the wear-resistance evaluation after the taber abrasion test was 5 determined.

4. Alkali Resistance Test

The coating film was immersed in an aqueous solution of 1 mol/l sodium hydrate for 6 hours, and then dried to observe the condition of the coating film.

Results of the above evaluations 1 to 4 are shown in Table .1.

TABLE 1

| | | Photo- | Wear Resistance | |
|---|---|---|---|---|
| | Appearance | catalysis | (Haze Differ- | Alkali |
| | (Haze: %) | (°) | ence: %) | Resistance |
| Example 1 | 0.2 | <5 | 1.0 | No change |
| Example 2 | 0.2 | <5 | 1.2 | No change |
| Example 3 | 0.1 | <5 | 0.5 | No change |
| Example 4 | 0.7 | <5 | 0.8 | No change |
| Example 5 | 0.1 | <5 | 5.2 | No change |
| Example 6 | 0.5 | <5 | 8.9 | Whitening |
| Example 7 | 0.2 | <5 | 0.8 | No change |
| Example 8 | 0.6 | <5 | 10.8 | Whitening |
| Example 9 | 1.2 | <5 | 0.5 | No change |
| Example 10 | 1.5 | <5 | 2.8 | Whitening |
| Comparative | 5.8 | 23.5 | Peeling | Peeling |
| Example 1 | | | | |
| Comparative | 5.4 | <5 | 1 | No change |
| Example 2 | | | | |
| Comparative | 0.3 | 28.3 | 0.9 | No change |
| Example 3 | | | | |
| Comparative | 3.2 | 18.4 | Peeling | Peeling |
| Example 4 | | | | |
| Comparative | 6.2 | <5 | Peeling | Peeling |
| Example 5 | | | | |
| Comparative | 0.3 | 23.1 | 0.8 | No change |
| Example 6 | | | | |

Despite of the baking temperature of 100° C., the coating films of Examples 1 to 10 show excellent photocatalysis and good appearance with a small haze. In addition, in all of the Examples, no peeling of the coating film was observed after the wear-resistance test and the alkali-resistance test.

With respect to film properties, comparisons between Examples 1 to 10 and Comparative Examples 1 to 6 show that even when TiO₂, the Zr containing compound, the hydrolyzable silicone resin and the Si containing compound containing SiO₂ particles are included in the composition, considerable differences in the film properties occur if the compounding ratio of them is not in the range defined in the present invention.

### INDUSTRIAL APPLICABILITY

According to the present invention, the photocatalyst-containing silicone resin composition, which is obtained by blending required amounts of TiO₂, a Zr containing compound, a hydrolyzable silicone resin and a Si containing compound containing SiO₂ particles, can be dried/cured at a relatively low temperature of from room temperature to approximately 200° C. The thus obtained film has high photocatalysis, hydrophilicity, durability, and alkali resistance. In addition, since the film with high transparency is obtained, it is possible to prevent a deterioration in appearance after the film formation.

Thus, by using the composition of the present invention, it is possible to use a material having a relatively poor heat resistance, which could not be used as a substrate in the conventional art, while keeping the photocatalysis at least equal to the conventional art. As a result, a degree of freedom of selection for the substrate increases, and expanding the applicability of the film with photocatalysis is expected.

1. A photocatalyst-containing silicone resin composition comprising TiO₂, a Zr containing compound, a hydrolyzable silicone resin and a Si containing compound containing SiO₂ particles, wherein a content of said Zr containing compound in terms of an oxide thereof is 0.005 to 0.1 parts by weight with respect to 1 part by weight of TiO₂, a content of said Si containing compound in terms of an oxide thereof is 0.5 to 6.0 parts by weight with respect to 1 part by weight of TiO₂, and a content of said SiO₂ particles is 0.1 to 3 parts by weight with respect to 1 part by weight in terms of an oxide of said hydrolyzable silicone resin.

2. The composition as set forth in claim 1, wherein the content of said Zr containing compound is 0.005 to 0.02 parts by weight.

3. The composition as set forth in claim 1, wherein said SiO₂ particles comprise a colloidal silica having an average particle size of 60 nm or less.

4. A cured film obtained by heat curing the composition as set forth in claim 1.

5. A coated article having a cured film obtained by heat curing the composition as set forth in claim 1.
